(19) United States
(12) Patent Application Publication
(10) Pub. No.: US 2023/0329960 A1
(43) Pub. Date: Oct. 19, 2023

(54) SELF-PROPELLING BODY LIMB MASSAGING DEVICE

(71) Applicant: Andre Maxim Persidsky, Mill Valley, CA (US)

(72) Inventor: Andre Maxim Persidsky, Mill Valley, CA (US)

(21) Appl. No.: 18/103,467

(22) Filed: Jan. 30, 2023

Related U.S. Application Data
(60) Provisional application No. 63/431,723, filed on Dec. 11, 2022.
(60) Provisional application No. 63/331,896, filed on Apr. 18, 2022.

(51) Int. Cl. A61H 15/00

(52) U.S. Cl. CPC A61H 15/0078; A61H 2015/0007; A61H 2201/1215; A61H 2201/1638; A61H 2201/1671; A61H 2201/1685; A61H 2201/1695; A61H 2201/5025

(57) ABSTRACT

The present invention relates to a self-propelling, portable massaging device which can move back and forth along an arm, leg, or other body part of a user while providing a massage to the user. In an embodiment, the massaging device comprises a massage element having ends, wherein the ends are attached to one or more rotational connectors forming a limb opening, wherein the limb opening is at least partially surrounded by the massage element, wherein a user inserts a body part into the limb opening for contact with and massaging by the massage element; the one or more rotational connectors connected to one or more motors, wherein the one or more rotational connectors cause a rotation of the ends when the one or more rotational connectors are rotated by the one or more motors.

### CROSS-REFERENCE TO RELATED APPLICATIONS

This application claims the priority benefit of U.S. provisional patent application No. 63/331,896 filed Apr. 18, 2022, titled “SELF-MOVING BODY LIMB MASSAGER”, and U.S. provisional patent application No. 63/431,723 filed Dec. 11, 2022, titled “SELF-MOVING BODY LIMB MASSAGER”; the entire contents of these applications are incorporated herein by reference.

### TECHNICAL FIELD

The present invention relates to a massaging device, in particular, to a self-propelling, portable massaging device which can move back and forth along an arm, leg, or other body parts of a user while providing a massage to the user.

### BACKGROUND OF THE INVENTION

Many different arm and leg massager devices are available today, which operate either in a manual or electronic form. For example, roller-based devices exist for manually massaging the arm, forearm, leg, calf, or other body parts of the user. The user can manually move or roll such a device back and forth across the desired body area, or alternately, can move his arm, hand, leg, or foot back and forth through a relatively stationary version of the device. Also, various massaging elements exist such as rollers, rotating balls, beads, and many more. Additionally, many vibration or pressure-based electronic massagers are available in various form factors for applying a vibration to a selected body area, or a controlled pressure using air for example.

However, one of the common problems with existing portable massaging devices is requiring the user to frequently move or reposition the device in order to target a new area or range of areas on the body for massage. This can negatively impact the relaxation effect sought by the user since it entails work and effort from the user. Special electronic massage devices such as chairs or massage cushions exist, which can largely automate the process of continuously moving a massage element through a pre-selected range of distance on the body, but these devices tend to be relatively large, expensive, and not particularly portable.

Japanese Patent Application Number JP2010029612A illustrates one of the existing massaging devices. In particular, the document proposes a massager with a bracelet function. Both ends of a curled cord, made of a soft material, are connected to each other via a ball in a ring form. One end of the curled cord is supplied with an adhesive and inserted into an installation hole of the ball made of acrylic resin, up to its middle. Similarly, the other end supplied with an adhesive is inserted into the hole from the opposite side and both the ends are connected to each other. Subsequently, a ring shape assembled with the curled cord and the ball is produced. A user can fit the ring between the thumb and the first finger through the palm and back of the hand. This arrangement allows the user to vary the intensity of the massage. For instance, when a strong massage is needed, the ball is brought to the palm, but when a weak or moderate massage is required, the curled cord is placed onto the palm and rolled to give the massage.

However, the device illustrated in JP2010029612A must be operated manually by the user throughout the duration of the massage. Consequently, the device does not allow the user to completely relax during the massage. Therefore, it is desirable to have a massaging device that operates automatically according to the massaging requirements of a user.

The information disclosed in this background of the disclosure section is only for enhancement of understanding of the general background of the invention and should not be taken as an acknowledgement or any form of suggestion that this information forms the prior art already known to a person skilled in the art.

### SUMMARY OF THE INVENTION

Disclosed herein is a self-propelling massaging device. The massaging device comprises a massage element having two ends. In an embodiment, the two ends of the massage element may be open, such that the massage element may be connected or attached to one or more rotational connectors using any suitable attaching means. Alternatively, the two ends of the massage element may be closed and/or plugged and connected to the one or more rotational connectors.

The ends of the massage element are attached to the one or more rotational connectors to form a limb opening, wherein the limb opening is at least partially surrounded by the massage element. A user inserts a body part into the limb opening for contact with and massaging by the massage element. The one or more rotational connectors are connected to one or more motors. The one or more motors provide a rotational movement to the one or more rotational connectors. The one or more rotational connectors cause a rotation of the ends of the massage element resulting in a rotation of the massage element, and the propelling of the massaging device along the limb inserted into the limb opening, when the one or more rotational connectors are rotated by the one or more motors. In an embodiment, the massage element may be rotated either from the ends connected to the one or more rotational connectors, or rotated with reference to any other point along the length of the massage element. As an example, the massage element may be rotated from the middle of the massage element.

Further, the present disclosure relates to a method of controlling operations of a self-propelling massaging device. The method comprises counting, by a control unit of the massaging device, a total number of rotations completed by the one or more rotational connectors in a first direction during operation of the massaging device. Further, the method comprises detecting an input provided by a user of the massaging device. Furthermore, the method comprises changing the movement of the one or more rotational connectors to a second direction upon detecting the user command. Thereafter, the method comprises counting a total number of rotations completed by the one or more rotational connectors in the second direction. Subsequently, the method comprises reversing the movement of the one or more rotational connectors to the first direction when the total number of rotations completed in the second direction is equal to the total number of rotations completed in the first direction, thereby facilitating automated propelling of the massaging device. In an alternative embodiment, the method may change the direction of the one or more rotational connectors based on a predefined time count instead of the number of rotations. That is, the one or more rotational connectors may be configured to reverse the direction of their movement after every 10 seconds of operation for example, causing a to-and-fro movement of the massage element on the surface of the body part. In an embodiment, the parameters such as speed of rotation and the predefined time count may be dynamically set by the user of the massaging device.

One object of the present invention is to provide a self-propelling massaging device which can independently move back and forth along a range of distance on a selected body area or limb such as an arm or leg, or other body areas such as the torso, neck, foot, hand, or fingers without requiring the user to move the device or frequently intervene in other aspects of its operation.

Another object of the present invention is to provide a self-propelling massaging device which can maintain adequate pressure as it moves along a body limb of varying diameter, to provide a pleasing and satisfying massage sensation to the user throughout the range of movement.

Another object of the present invention is to provide a self-propelling massaging device which can utilize a massage element that can dynamically vary in diameter to accommodate the changing diameter of a body limb as the massaging device moves along its length.

Another object of the present invention is to provide a detachable and replaceable massage element which can be provided in different lengths to accommodate different diameter body areas with large average differences in diameter such as a leg or arm.

Another object of the present invention is to provide a self-propelling massaging device for which the range of distance traveled on the body can be cycled based on an input provided by the user.

In another object of the present invention, the self-propelling massaging device can be powered by a rechargeable battery to make it convenient to reuse.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed principles. The same numbers are used throughout the figures to reference like features and components, in which:

FIG. 1 shows an exemplary front view of a first embodiment of the proposed self-propelling massaging device.

FIGS. 1A and 1B show the placement of the massage element on the user's body part (i.e., arm of the user) inserted through the limb opening of the massage element.

FIGS. 1C and 1D show exemplary views of a functional prototype of the proposed massaging device.

FIG. 2 shows an exemplary transparent front view of a first embodiment of the self-propelling massaging device.

FIG. 3 shows an exemplary block diagram of a control unit of the self-propelling messaging device.

FIG. 4 shows a top view of a first embodiment of the massage element.

FIG. 5 shows an exemplary variation in the structure of the massage element.

FIG. 6 shows an exemplary flowchart illustrating a method of controlling the self-propelling messaging device.

FIG. 7 shows an exemplary front view of a second embodiment of the proposed self-propelling massaging device with the cover removed.

FIG. 8 shows an exemplary front view of a second embodiment of the self-propelling massaging device with the cover in place.

FIG. 9 shows a sectional view of the second embodiment of the self-propelling massaging device.

FIG. 10 shows an alternate embodiment of the self-propelling massaging device where rotational connectors or secondary massage elements are actively rotated by a motor.

FIG. 11 shows a partial view of a massage element where the coils are textured with small protrusions.

FIG. 12 shows a bottom perspective view of a second embodiment of the self-propelling massaging device with a vibrational device inside.

FIG. 13 shows a front rendered view of the self-propelling massaging device utilizing two separate massage elements.

FIG. 14A shows a front rendered view of an alternate embodiment of the self-propelling massaging device where the motors are driving the secondary massage elements, and the massage element freely rotates on its own.

FIG. 14B shows a front rendered view of an alternate embodiment of the self-propelling massaging device where one motor is driving the rotation of a massage element, and a second motor is driving the rotation of one secondary massage element.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternatives falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

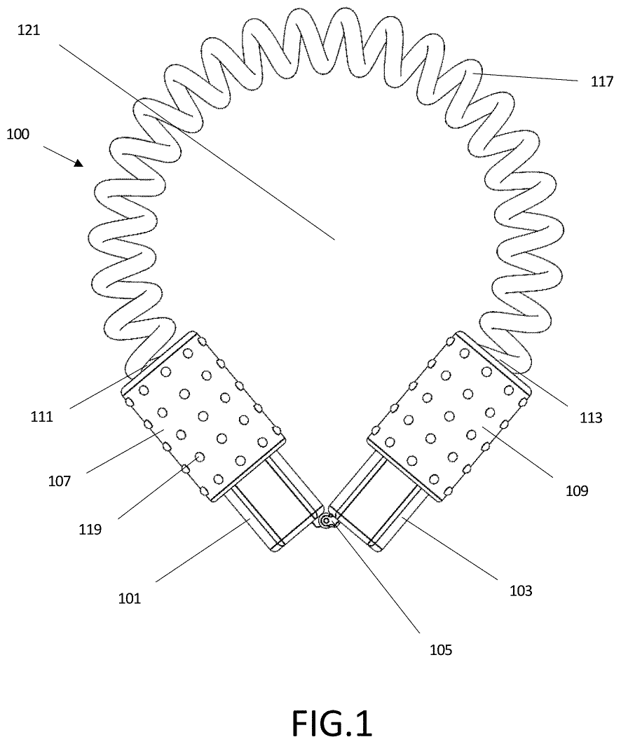

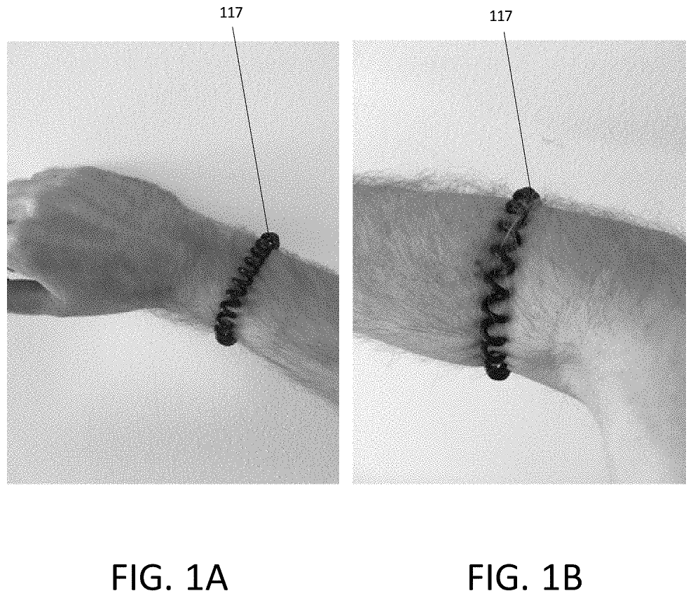

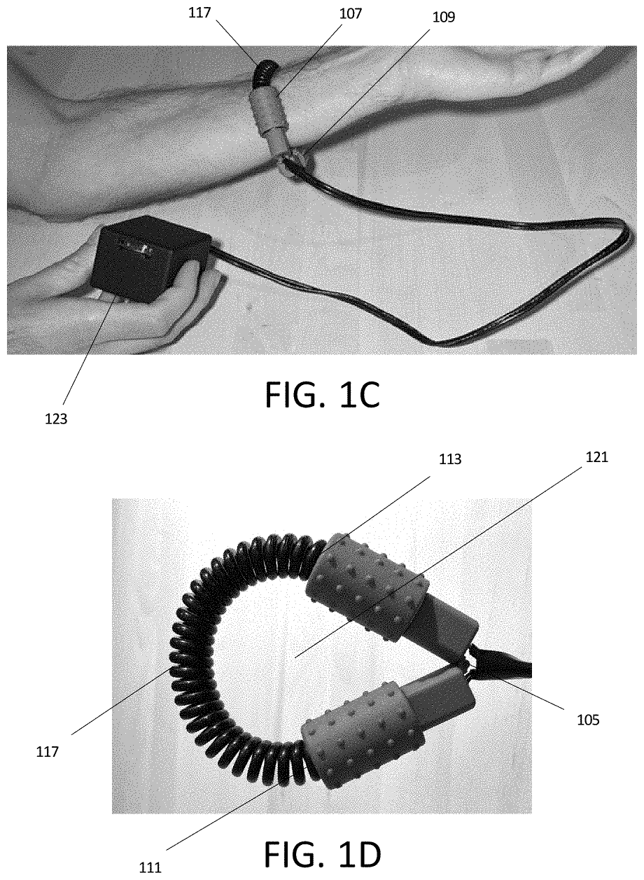

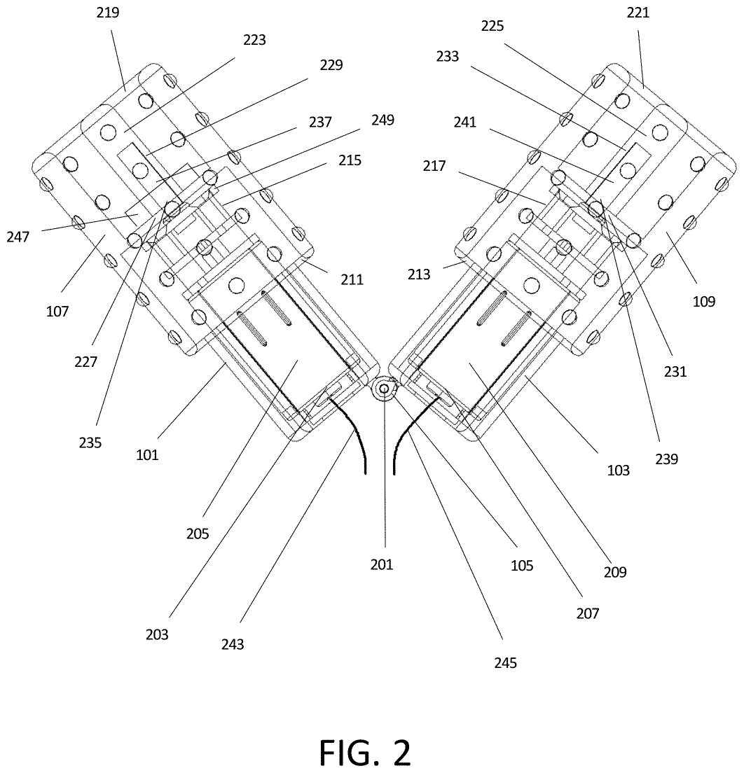

A first embodiment of a self-propelling massaging device 100 or massaging device 100 is shown in FIGS. 1-2. In an embodiment, massaging device 100 can include two motor housings 101 and 103, connected by a hinge 105, allowing motor housings 101 and 103 to rotate around a hinge axis 201 as shown in FIG. 2. Further, as shown in the transparent view in FIG. 2, the motor housings 101 and 103 can be open on their top ends for inserting and holding lower motor sections 203 and 207 of motors 205 and 209. The motors 205 and 209 are used to rotate rotational connectors 107 and 109 fitted onto the motor shafts 237 and 241. Further, the rotational connectors 107 and 109 can be cylindrically shaped to function as rollers, with open proximal compartments 211 and 213 into which upper motor sections 215 and 217 of motors 205 and 209 are inserted and held.

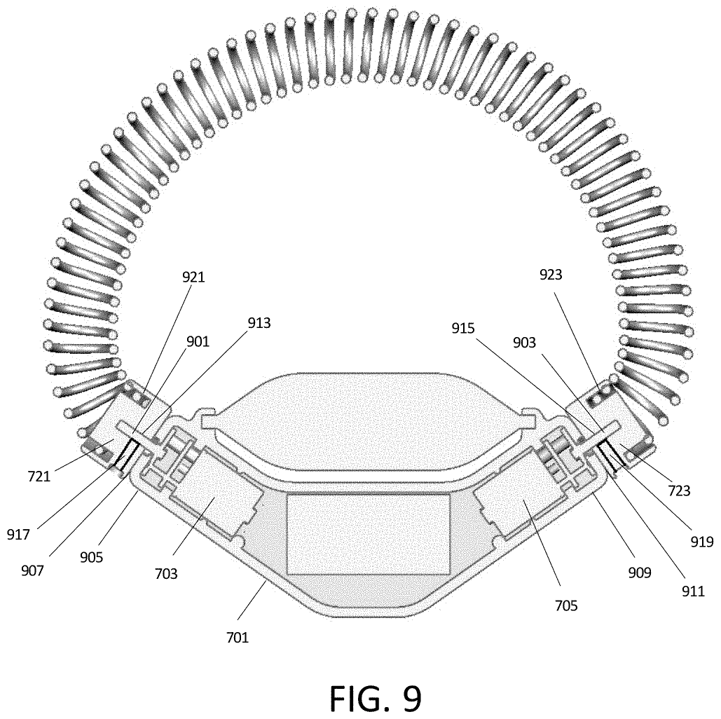

In an embodiment, the diameters of rotational connectors 107 and 109 are wide enough to provide clearance to rotate around the contained upper motor sections 215 and 217, as well as motor housings 101 and 103 which can partially reside therein. The top ends of rotational connectors 107 and 109 can have open distal compartments 219 and 221 for holding the ends 111 and 113 of a massage element 117 as shown in FIG. 1, and can be secured in a similar manner therein, for example, as shown in FIG. 9 for circular channels 921 and 923. The open distal compartments 219 and 221 can contain motor shaft posts 223 and 225 mounted onto center walls 227 and 231 inside of rotational connectors 107 and 109.

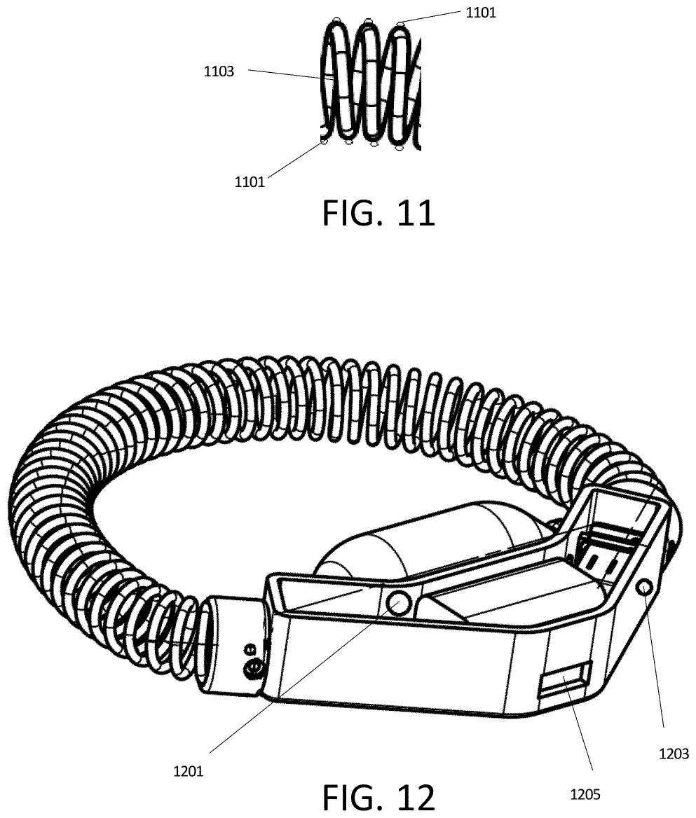

In an embodiment, the ends 111 and 113 of the massage element 117 may have a central open axis 1103 as shown in FIG. 11. The central open axes 1103 of the ends 111 and 113 can be placed over motor shaft posts 223 and 225 and secured by gluing for example. In an embodiment, the motor shaft posts 223 and 225 can contain shaft channels 229 and 233 with openings 235 and 239 from the proximal sides of center walls 227 and 231 for inserting and holding motor shafts 237 and 241. The motor shafts 237 and 241 can be ‘D’ shaped shafts for example, fitting into shaft channels 229 and 233, which can have corresponding female ‘D’ shaped profiles. In this overall arrangement, the rotational connectors 107 and 109 are covering and rotating around upper motor sections 215 and 217, while motor housings 101 and 103 contain and hold lower motor sections 203 and 207 to ensure that only motor shafts 237 and 241 and attached rotational connectors 107 and 109 rotate when motors 205 and 209 are switched on. In an implementation, the massage element 117 may have a coiled structure as shown in FIG. 4.

In an embodiment, the rotational connectors 107 and 109 which rotate the ends 111 and 113 of the massage element 117, can also further function as secondary massage elements (and be referred to as secondary massage elements 107 and 109 hereinafter), for example functioning as massage rollers which roll along and press against a limb such as an arm or leg and also assist in moving or propelling massaging device 100 along the limb. Combining the functions of rotational connectors and secondary massage elements provides a more compact and efficient design. Secondary massage elements 107 and 109 can be a roller for example, a ball transfer bearing, kneading-type ball-based massage elements, or other rotational structures. In case of a ball structure, it can have similar means for attaching ends 111 and 113 of massage element 117, as already discussed. It can optionally have a variety of textures on its surface, such as small bumps or protrusions for example, for enhancing the massage sensation while rolling against a body limb, and can be made from plastic, rubber, or other materials.

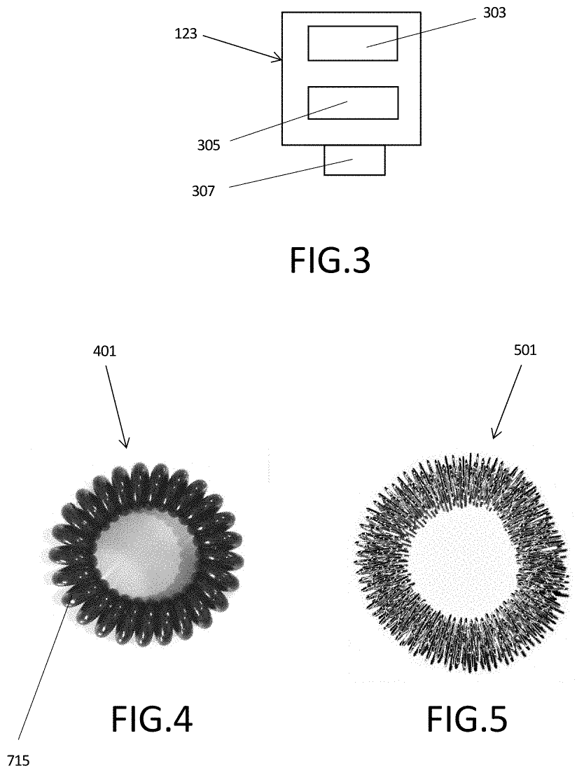

In an embodiment, the massaging device 100 can include a battery, a Printed Circuit Board (PCB), a user interface, comprising at least one or more buttons, and can include a switch, which enables a user for turning the device ‘ON’ or ‘OFF’. For example, motor housings 101 and 103 can be enlarged to contain these electrical components. Alternately, an external control unit or a control box 123 can be provided as shown in FIG. 3 and FIG. 1C for controlling the operation of massaging device 100. The control box 123 can include a battery 303, which may be a rechargeable battery, an optional PCB 305 similar to the PCB 709 later described, and a user control interface 307 which may comprise, without limiting to, one or more buttons, a 3-way slider switch for example, or other input means. The control box 123 can be electrically connected to motors 205 and 209 by wires 243 and 245 for example as shown in FIG. 2, for controlling the motors 205 and 209, or can be wirelessly connected to control motors 205 and 209 by using a wireless communication interface such as Bluetooth for example.

In an embodiment, to operate the massaging device 100, a user places a limb such as an arm or leg into a limb opening 121, as shown in figures FIG. 1, FIG. 1C, and FIG. 1D such that the massage element 117 at least partially surrounds the limb. The user can then operate user control 307 to turn on the motors and set their rotational directions. For example, the secondary massage elements 107 and 109 can both rotate inwards or outwards along with the massage element 117 to propel massaging device 100 proximally or distally along a limb. For example, the user can also manually operate user control 307 to change the direction of movement of massaging device 100 by changing the rotational direction of motors 205 and 209, in which case a PCB 305 may not be needed which simplifies manufacturing, or the user can set a program to automatically change directions along a limb, in which case it is preferable to include PCB 305.

In an embodiment, as the massaging device 100 moves along a limb of varying diameter as shown in FIGS. 1C and 1D, hinge 105 allows motor housings 101 and 103 along with secondary massage elements 107 and 109 to rotate towards or away from each other to accommodate the limb diameter of various shapes, and to keep secondary massage elements 107 and 109 more flat against the limb surface to help maximize contact as it moves, while the massage element 117 stretches in diameter.

The secondary massage elements 107 and 109 along with attached massage element 117 can be removeable from massaging device 100 and replaced with another set (secondary massage elements together with attached massage element), allowing the user to change the length of the deployed massage element 117, or the surface textures or bumps of the secondary massage elements, or just to replace these parts if worn out. For example, when using the massaging device 100 on an arm, the desirable length of massage element 117 may be shorter than when using the device on a thigh. In an embodiment, allowing to change the lengths of the massage element 117 also helps to accommodate naturally occurring ranges in body dimensions between different people. The secondary massage elements 107 and 109 can include a magnet 247 for example as shown in FIG. 2 for secondary massage element 107, which can be a ring magnet fitted over shaft post 223 and resting and secured to center wall 227. The magnet can be magnetically attracted to a plate 249 on motor 205. The plate 249 can be part of motor 205 or can for example be an external stainless-steel washer placed over motor shaft 237. In this arrangement, the secondary massage elements 107 and 109 can be magnetically held on motor shafts 237 and 241 as they rotate, preventing them from inadvertently sliding off while in contact with a limb. When the user applies a sufficient pulling force, they can break the magnetic hold and slide off secondary massage elements 107 and 109 from motor shafts 237 and 241, along with attached massage element 117 for replacement.

In an embodiment, the massage element 117 can consist of coils 715, and has a structure similar to a spiral hair tie 401 as shown in FIG. 4, which is typically used to hold women's hair in a ponytail for example, also similar to a coiled phone cord. Spiral hair ties, sometimes also known as coiled hair ties or phone cord hair ties, have interesting and useful properties with respect to the present invention. They are highly elastic and easily stretchable to varying diameters. Another useful property is that it can be twisted along its main longitudinal axis, even when that axis is on a curved path. For example, while holding a spiral hair tie at two opposite points on its diameter and rotating its coils in opposite directions with fingers, one can twist the entire spiral hair tie inwardly or outwardly even while it maintains a circular or arc or ring shape. This property makes it possible to move or roll the spiral hair tie along a limb as shown in FIGS. 1A and 1B, while its elasticity allows it to stretch in diameter to accommodate limbs of varying widths along their lengths, while consistently gripping the limb with circumferential pressure. Another useful property is that the coiled wire (or coiled cord or coiled band) structure of the spiral hair tie can impart a pleasing massage sensation as it rolls against the skin, with each coil functioning like a mini roller. The massage element 117 can differ from a typical spiral hair tie in that it's not closed into a loop or continuous ring. Rather, its ends 111 and 113 are attached to rotational connectors as previously discussed for causing its rotation.

FIG. 5 shows an alternate structure 501 for the massage element 117. In an embodiment, the structure 501 can be similar to acupressure massage rings, which utilize small triangular shaped connected metal scaffolds. The structure 501 is also able to change its diameter when rolling along a limb while applying pressure. In an embodiment, many such different alternate structures for the massage element 117 may be possible within the scope of the present invention, such as various elastic bands or cords, coiled or non-coiled for example.

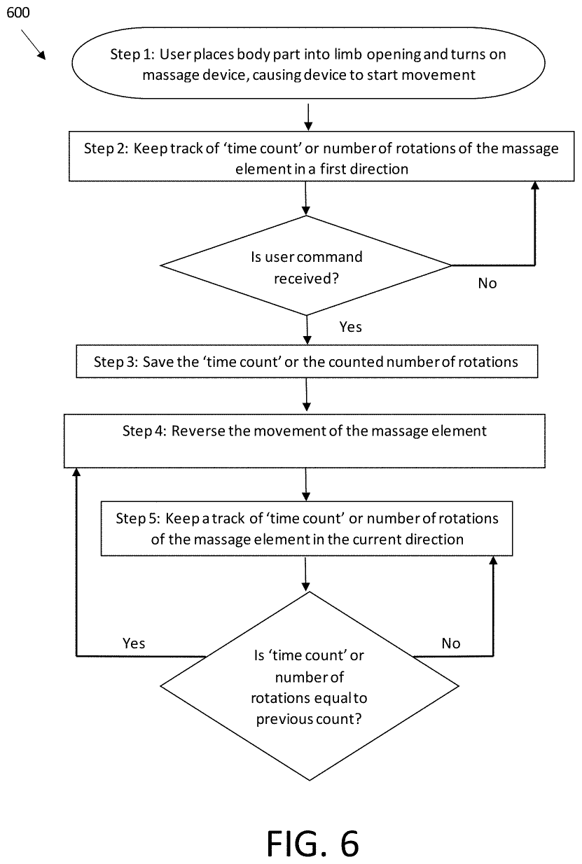

FIG. 6 shows a flowchart detailing a method 600 to control the operations of the proposed self-propelling massaging device. In step 1, a user's body limb is placed into limb opening 121 and massaging device is turned on, activating the rotation of motors 205 and 209 causing massaging device 100 to start traveling. In step 2, the control unit can start counting how many turns the motor shafts 237 and 241 and consequently massage element 117 are undergoing. For example, based on the known rotational speed of the motors 205 and 209, the number of rotations can be counted based on elapsed time. Alternatively, the control unit may measure a total time elapsed (referred as ‘time count’) since the massaging device has started moving in a particular direction. In step 3, when the user issues a user command, for example by pressing the button 1203, the method 600 can save the ‘time count’ or the total number of turns that the shaft motor has taken to reach that point. In step 4, the motors 205 and 209 are reversed in direction by the CPU which is running the method 600 for example. In step 5, the method 600 again can measure the ‘time count’ or count the motor shaft turns on the reverse travel direction. When this is equal to the saved values in step 3, this corresponds to massaging device 100 reaching its starting location. Subsequently, the method 600 can jump back to step 4, where the massaging device 100 reverses direction again and continues moving to its saved reversal point to repeat the cycle.

The motors 205 and 209 can be relatively high torque electrical motors, and can use gear box speed reduction for example as is well known in the art. Motor speed can preferably vary and be controllable by CPU 711, for example, by varying the voltage. Speed for example can include 30 or 60 RPM, but can be set higher or lower.

In an embodiment, the control unit or CPU 711 of the massaging device could be wirelessly controllable by using a mobile phone application, for example, through a Bluetooth connection. Such an application could be used to define the range of motion, select preset ranges, and set more complex programs and options, such as when to turn on a vibrational device 1201, for how long the massage should take place, when to vary the range of motion, and the speed of motors 205 and 209 for setting how fast massaging device 100 moves along the limb. In another example, the massaging device 100 could be set to move up and down on a leg for 10 minutes to aid in falling asleep while lying in bed. As an example, after 10 minutes, the device could automatically move completely off the leg and foot and shut down.

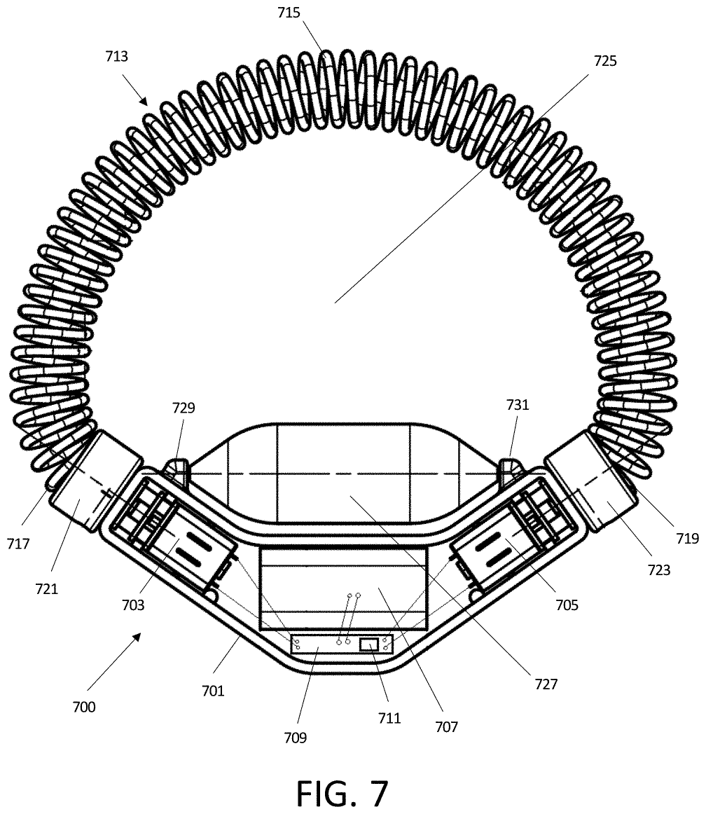

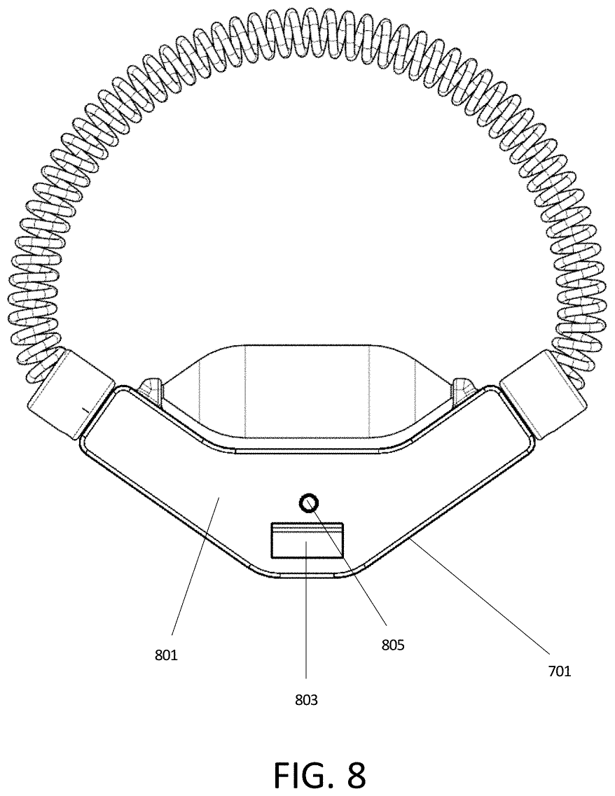

A second embodiment of the self-propelling massaging device 700 or massaging device 700 is shown in FIGS. 7-9. The Massaging device 700 consists of a housing 701 which can contain motors 703 and 705, a battery 707, and a PCB 709 with a CPU 711. The housing 701 can have a cover 801 as shown in FIG. 8, which can be closed using screws or gluing for example. Further, as shown in FIG. 7, the self-propelling massaging device 700 utilizes a massage element 713 similar to the massage element 117 to circumferentially grip, massage, and move massaging device 700 along a limb of varying diameter, such as an arm or leg, or torso or neck. The massage element 713 mainly differs from a typical spiral hair tie in that it's not closed into a loop. Rather, its cut ends 717, 719 (also referred as coiled ends 717, 719 or open ends 717, 719 or ends 717, 719) are attached to rotational connectors 721 and 723, forming a limb opening 725 through which an arm, leg, foot, or hand for example can be inserted. A secondary massage element 727 can be mounted as shown on posts 729 and 731 on housing 701 at the bottom of limb opening 725 for providing an additional massage on the section of the limb not in contact with massage element 713, and to assist in moving massaging device 700 along the limb. Secondary massage element 727 can be a roller for example, a ball transfer bearing, kneading-type ball-based massage elements, or other rotational structure. It can optionally have a variety of textures on its surface, such as small bumps or protrusions for example, for enhancing the massage sensation, and can be made from plastic, rubber, or other materials.

In an embodiment, the housing 701, rotational connectors 721 and 723, cover 801, and secondary massage element 727 can be made from plastic for example, using injection molding. Other materials can be used such as aluminum or other metals as well. The battery 707 can be a rechargeable battery such as lithium ion, and charged using a USB cable for example connected to a USB port 803 as shown in FIG. 8, as well known in the art. A charging status LED 805 can be provided, which can turn green when the device is fully charged or show red when charging is needed.

In the second embodiment, as shown sectionally in FIG. 9, the housing 701 can have wing ends 905 and 909 where motors 703 and 705 can be mounted therein. The rotational connectors 721 and 723 can be mounted on exterior surfaces 907 and 911 of wing ends 905 and 909 and attached to motor shafts 901 and 903 of motors 703 and 705, such that when motor shafts 901 and 903 are rotating, rotational connectors 721 and 723 are rotating along with them. A small gap can be provided between rotational connectors 721 and 723 and exterior surfaces 907 and 911 to reduce friction. Motor shafts 901 and 903 can be D shaped for example or cylindrically shaped and inserted into corresponding female axes 913 and 915 in rotational connectors 721 and 723. Set screws 917 and 919 can be used to secure rotational connectors 721 and 723 with respect to motor shafts 901 and 903, and to keep massage element 713 locked onto massaging device 700. The rotational connectors 721 and 723 can have circular channels 921 and 923 for holding cut ends 717 and 719 of massage element 713. Cut ends 717 and 719 can be glued for example inside circular channels 921 and 923 for holding one or more coils 715 therein for transmitting twisting motion onto massage element 713. The massage element 713 can be replaced by the user. For example, if the user wishes to target a wider body limb like a leg, they can replace or interchange the massage element 713 with different sizes. The massage elements could be provided with rotational connectors already secured to their ends, so the user would only need to loosen the set screws to replace them for example.

In an embodiment, when the motors 703 and 705 are turned on, and motor shafts 901 and 903 are rotating in opposite directions along with rotational connectors 721 and 723, this causes overall massage element 713 to rotate inwardly or outwardly, wherein all coils 715 rotate together inwardly or outwardly against the at least partially surrounded or encompassed skin of a body limb in the case where massage element is implemented as the coiled structure in FIG. 4. This can be used to drive the overall movement of massaging device 700 or 100 along a limb, when the limb is inserted into limb opening 725, in either the proximal or distal direction, depending on if coils 715 are rolling either inwardly or outwardly. By making the wing ends 905 and 909 angled, and consequently the orientations of motors 703 and 705 and rotational connectors 721 and 723 angled as shown in FIG. 7 and FIG. 9, this can help to stretch, encompass, and grip massage element 713 around the sides of a body limb in addition to the surface of the limb in contact with the top part of massage element 713. This in turn helps to provide a more uniform massage around the body limb, as well as to help move the device along the limb by being in contact with a greater circumferential surface area of the limb compared to if motors 703 and 705 were just mounted vertically with respect to massage element 713, though such vertical mounting is possible within the scope of the present invention.

In an embodiment, to help facilitate this angled placement of motors 703 and 705, the housing 701 can be approximately ‘V’ shaped for example as shown in FIG. 7, or shaped like a segment arc of a circle, or more generally curved, but many other housing shape configurations are possible such as rectangular or square within the scope of the present invention. While the massaging device 700 moves along a limb, massage element 713 also functions as a spring, pulling housing 701 with attached secondary massage element 727 upwards against a surface of the limb to apply pressure while rolling against the skin. This allows secondary massage element 727 to cover and massage that area of the limb not in contact with massage element 713. In the present embodiment, secondary massage element 727 is passively rotating due to the motor-driven rotation and movement of massage element 713.

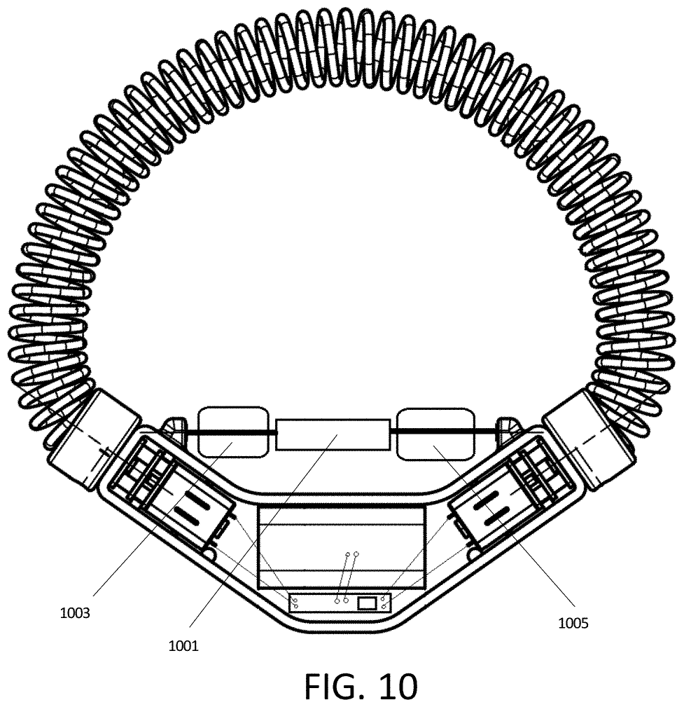

In an alternate embodiment as shown in FIG. 10, the secondary massage element could be actively rotating by utilizing a secondary massage element motor 1001 to further assist in propelling massaging device 700 along a limb. Secondary massage element motor 1001 could for example be a dual shaft motor with secondary massage elements 1003 and 1005 mounted on the shafts as shown, or could be a single shaft motor with a single driven roller. Secondary massage elements 1003 and 1005 can be rollers for example.

In an embodiment, the coils 715 of massage element 713 or massage element 117 could be made from TPU for example, or other non-toxic and flexible plastic materials for contact with the skin. Furthermore, coils 715 could be optionally textured with small bumps or protrusions 1101 as shown in FIG. 11 to aid in the frictional movement of massage element 713 against the skin. Optionally, protrusions 1101 could be made from rubber for example, for enhanced frictional gripping strength against the skin as coils 715 roll inwards or outwards.

In an embodiment, as shown in FIG. 12, the vibrational device 1201 can be optionally included in housing 701 for the purpose of also vibrating secondary massage element 727 as it rolls against the skin to further enhance the massage sensation. The vibrational device 1201 can be a coin cell buzzer for example, a vibrating motor, or any other electronic vibrating device. Further, as shown in FIG. 12, a range setting button 1203 can be provided. Button 1203 can be connected to CPU 711 for the purpose of setting the cycling travel range on the body limb. In one example, to operate massaging device 700, the user can first insert a body limb into limb opening 725, and then turn on massaging device 700 by moving a slider switch 1205 to it's on position so that motors 703 and 705 begin turning. The user can then allow massaging device 700 to travel to the point on the limb where they wish it to reverse direction, for example, from the hand to the top of the bicep muscle. At that location, the user can press button 1203 so that method 600 running on CPU 711 can save the reversal point. The massaging device 700 can then travel back to its starting location, and then automatically reverse direction again and cycle on the defined range indefinitely or for a set period of time.

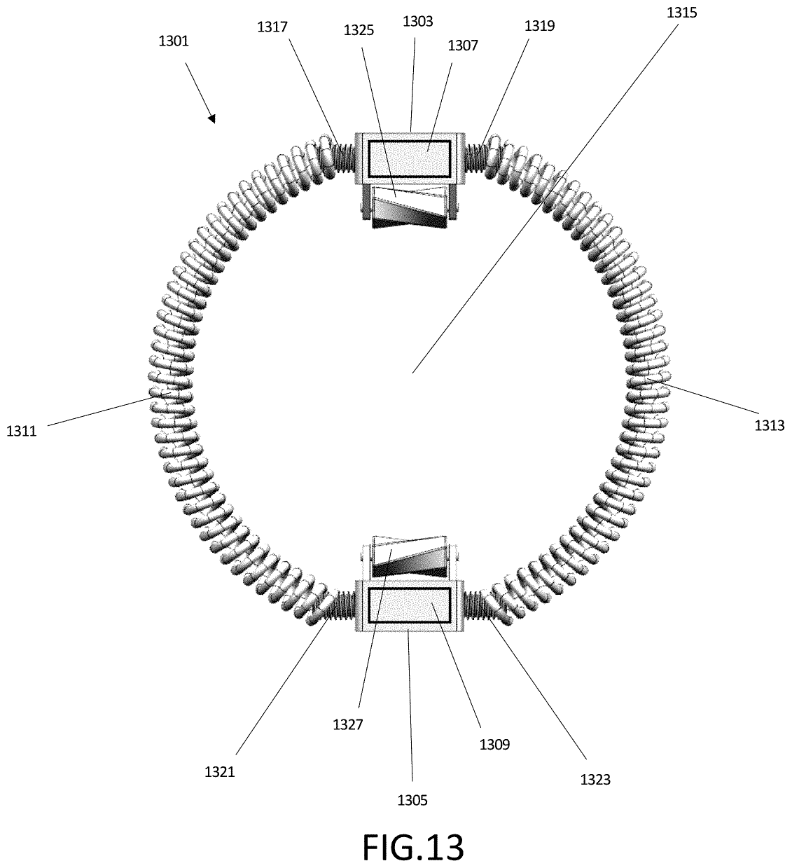

Another embodiment of the self-propelling massaging device 1301 is shown in FIG. 13. In an embodiment, instead of one housing 701, two separate housings 1303 and 1305 can be provided with motors 1307 and 1309 mounted therein. The motors 1307 and 1309 can be dual shaft motors. Two separate massage elements 1311 and 1313 can be utilized. forming a limb opening 1315 between them. A pair of rotational connectors 1317 and 1319 and 1321 and 1323 on each housing can be provided, to simultaneously rotate massage elements 1311 and 1313. Further, side rollers 1325 and 1327 can be mounted on housings 1303 and 1305 to cover and massage the region on the limb not in contact with massage elements 1311 and 1313. In an embodiment, almost the entire body limb can be surrounded or encompassed by massage elements 1311 and 1313. Housings 1303 and 1305 could each have their own batteries and USB charging ports similar to what was already described for massaging device 100 and 700. The user could simultaneously charge both sides by using two USB cables for example. Pressure against the limb during the massage and movement of the device 1301 would help to prevent housings 1303 and 1305 from rotating due to motor rotation.

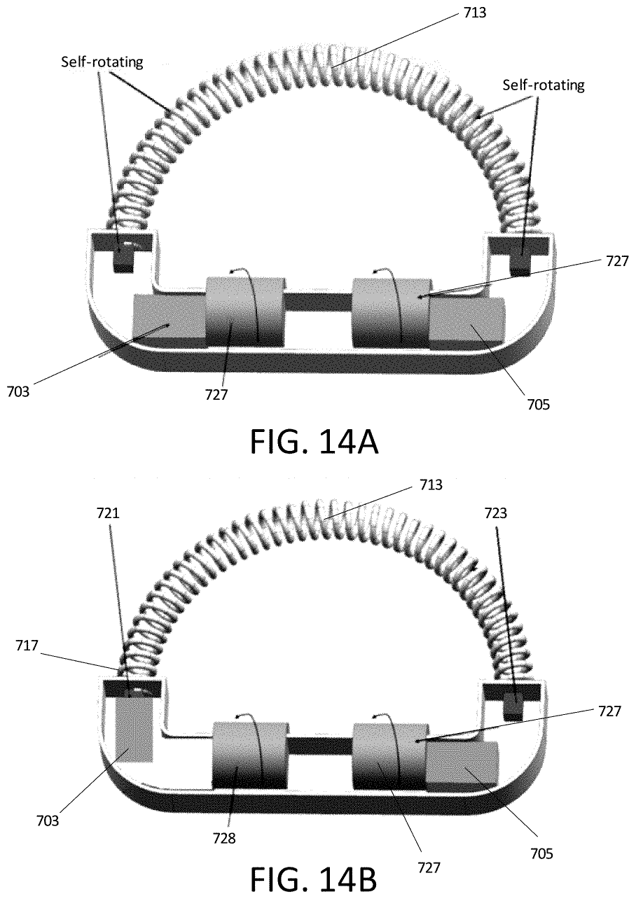

FIG. 14A shows another alternate embodiment, wherein the motors 703 and 705 could instead be connected to secondary massage elements 727, which could be one or more rollers for example as shown, and with massage element 713 not connected to any motors and passively rotating. In another alternate embodiment as shown in FIG. 14B, motor 703 can be used to rotate one cut end 717 of massage element 713, using rotational connector 721. In this case, rotational connector 723 on the opposite side would not be connected to a motor but could just freely rotate. In an embodiment, the motor 705 could instead be connected to secondary massage element 727 to drive its rotation for example, and another secondary massage element 728 could rotate freely on its own as shown without a motor. Many such combinations are possible within the scope of the present invention.

In light of the technical advancements provided by the proposed disclosure, it shall be noted that the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true spirit being indicated by the following claims.

1. A self-propelling massaging device comprising:
a massage element having ends, wherein the ends are attached to one or more rotational connectors forming a limb opening, wherein the limb opening is at least partially surrounded by the massage element, wherein a user inserts a body part into the limb opening for contact with and massaging by the massage element;
the one or more rotational connectors connected to one or more motors, and
wherein when the one or more rotational connectors are rotated by the one or more motors, the one or more rotational connectors cause a rotation of the ends.

2. The massaging device of claim 1, wherein the massage element is detachable and replaceable from the massaging device.

3. The massaging device of claim 1, wherein the massage element is configurable with a plurality of textured protrusions for causing an enhanced massage stimulation to the body part.

4. The massaging device of claim 1, wherein the massage element is made of an elastic material.

5. The massaging device of claim 1, wherein a diameter of the massage element dynamically adapts to a diameter of the body part during the self-propelling movement of the massaging device.

6. The massaging device of claim 1, wherein the ends of the massage element are attached to the one or more rotational connectors through an attaching structure comprising a circular channel holder.

7. The massaging device of claim 1, wherein the massage element consists of coils.

8. The massaging device of claim 7 wherein the massage element is structurally similar to a spiral hair tie or coiled phone cord.

9. The massaging device of claim 1, wherein when the one or more rotational connectors causes a rotation of the ends, the massage element is also caused to rotate.

10. The massaging device of claim 9, wherein the rotation of the massage element causes the massaging device to move along the body part inserted into the limb opening, thereby providing a self-propelling massage to the body part.

11. The massaging device of claim 1, wherein the one or more rotational connectors function as secondary massage elements in contact with the body part inserted into the limb opening, and aid in the movement of the self-propelling massaging device along the body part.

12. The massaging device of claim 11, wherein each of the one or more secondary massage elements comprise a plurality of protruding elements around an outer surface of the one or more secondary massage elements to provide an enhanced massage stimulation to the body part.

13. The massaging device of claim 1, wherein the one or more motors are housed in:
one or more motor housings, and comprise:
a hinge connecting the one or more motor housings, such that the one or more motor housings rotate around an axis of the hinge during movement of the self-propelling massaging device, and
wherein each of the one or more motors comprise a motor shaft on which the one or more rotational connectors are fitted.

14. The massaging device of claim 1, wherein the massaging device further comprises a control unit for controlling operation of the massaging device, wherein the control unit comprises:
a Printed Circuit Board (PCB) with a processing unit configured to perform one or more control operations on the one or more motors;
at least one rechargeable battery for powering the massaging device; and
a user interface to receive a user input for controlling operations of the massaging device.

15. The massaging device of claim 14, wherein the control unit is configurable within the motor housing or external to the massaging device.

16. The massaging device of claim 14, wherein the one or more control operations comprises at least one of:
setting a distance range for each cycle of movement of the massage device along the body part, controlling speed of rotation of the one or more motors, and power-on or powering-off of the massaging device.

17. The massaging device of claim 14, wherein the one or more control operations are autonomously controlled by the control unit or manually controllable by a user of the massaging device.

18. The massaging device of claim 14, wherein the user interface includes at least one of a touch interface, a keypad, button, a toggle switch, or a mobile application installed on an external user device communicatively connected to the massaging device.

19. A method of controlling operations of a self-propelling massaging device of claims 1-18, the method comprising:
tracking, by a control unit of the massaging device, at least one of a ‘time count’ or a total number of rotations completed by the one or more rotational connectors in a first direction during operation of the massaging device;
detecting, by the control unit, a user input provided by a user of the massaging device;
changing, by the control unit, the movement of the one or more rotational connectors to a second direction upon detecting the user input;
tracking, by the control unit, at least one of the ‘time count’ or a total number of rotations completed by the one or more rotational connectors in the second direction; and
reversing, by the control unit, the movement of the one or more rotational connectors to the first direction when the ‘time count’ or the total number of rotations completed in the second direction is equal to the ‘time count’ or the total number of rotations completed in the first direction, thereby facilitating automated propelling of the massaging device.

20. The method of claim 19, wherein the user input is received through at least one of a user interface configured on the massaging device or a mobile application installed on a user device, wherein the user device is communicatively connected to the massaging device.
